(19) United States
(12) Patent Application Publication
(10) Pub. No.: US 2002/0070559 A1
(43) Pub. Date: Jun. 13, 2002

(54) Dynamic energy storage device for sport appliances

(75) Inventor: Edward Chen, Taipei (TW)

Correspondence Address: DOUGHERTY & TROXELL, SUITE 1404, 5205 LEESBURG PIKE, FALLS CHURCH, VA, 22041, US

(73) Assignee: SUNPENTOWN ELECTRIC CO., LTD.

(21) Appl. No.: 09/725,187

(22) Filed: Nov. 29, 2000

(51) Int. Cl. H02P 9/04; B60L 11/12

(52) U.S. Cl. 290/50

(57) ABSTRACT

A dynamic energy storage device for sport appliances, being characterized by transmitting a dynamic force of the transmitting system of a sport appliance such as an exercise bike to an out-extending rotating axle of an electric power generator by means of a transmitting mechanism, wherein the electric power generator is connected to a chargeable battery device through conductors; the chargeable battery device is provided in a matchable container, more than one electric sockets or other display devices are provided on the container through a connecting circuit structure therein. So that when in use of the sport appliance, the electric power generated by the electric power generator from dynamic energy can be stored in the chargeable battery device as spare electric power for emergency.

### BACKGROUND OF THE INVENTION

1. Field of the Invention

The present invention is related to a dynamic energy storage device for sport appliances, and especially to a storage device able to convert dynamic energy of a sport appliance into spare electric energy.

2. Description of the Prior Art

People live in the modern living and working types can hardly have chances to get sufficient exercises, plus the space of life which is getting smaller from day to day, it is inconvenient for them to do healthy exercises in a wider space.

As to this, indoor sport appliances such as an exercise bike, an exercise rowboat, an exercise runway etc. provide sport tools which are not limited by time, weather and space. As to a modern indoor exercise bike or exercise runner, it not only provides a function for sustaining treading or running, but also provides a displayer to show the amount of exercising with a related accessory (such as a meter or timer to show the miles or time in treading or running done).

To get the required amount of exercising, when a user uses one of such sport appliances indoors, he often stays for a predetermined time period, such as to continuously tread on an exercise bike for half an hour, an hour or longer. Generally, on such an indoor sport appliance, after exercising on the sport appliance, energy in sporting is wasted without any measures to deal with, it is a pity.

In normal life of people, it happens that electric power is broken during a natural calamity (such as an earthquake or a typhoon) and people stay in the case that no illumination can be provided by electricity or no electric power can be provided for household electric appliances.

### SUMMARY OF THE INVENTION

Thereby, the object of the present invention is to provide a dynamic energy storage device for sport appliances, the dynamic energy generated by the sport appliances during sporting can be converted into spare electric energy.

To obtain the object, the present invention communicates straight-line or circling movement on a sport appliance with a rotating axle of an electric power generating device, the electric power generating device can be connected via conductors to a neighboring chargeable battery device. Thereby, the battery device can be a spare electric power storage device.

The stated battery device can be a stationary one or a portable one to be carried to any desired location for use at any time.

The abovementioned chargeable battery device can also be provided with an external electric socket or some display device cooperating with a container thereof to display the situation of power supplying.

In a preferred embodiment of the present invention, an exercise bike is taken as an example for illustration; however, the structure described below can also be used for other sport appliances.

The present invention will be apparent in its novelty and features after reading the detailed description of the preferred embodiment thereof in reference to the accompanying drawings.

### BRIEF DESCRIPTION OF THE DRAWINGS

FIG. 1 is a front view showing using a preferred embodiment of the present invention on an indoor exercise bike;

FIG. 2 is a side view of FIG. 1; and

FIG. 3 is a top view of FIG. 1.

### DETAILED DESCRIPTION OF THE PREFERRED EMBODIMENT

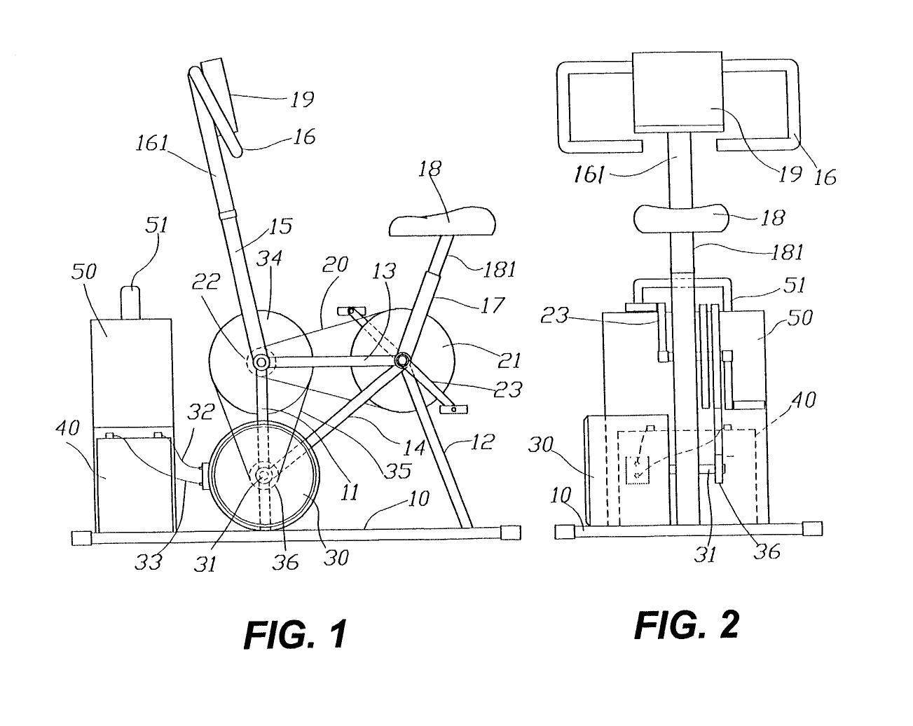

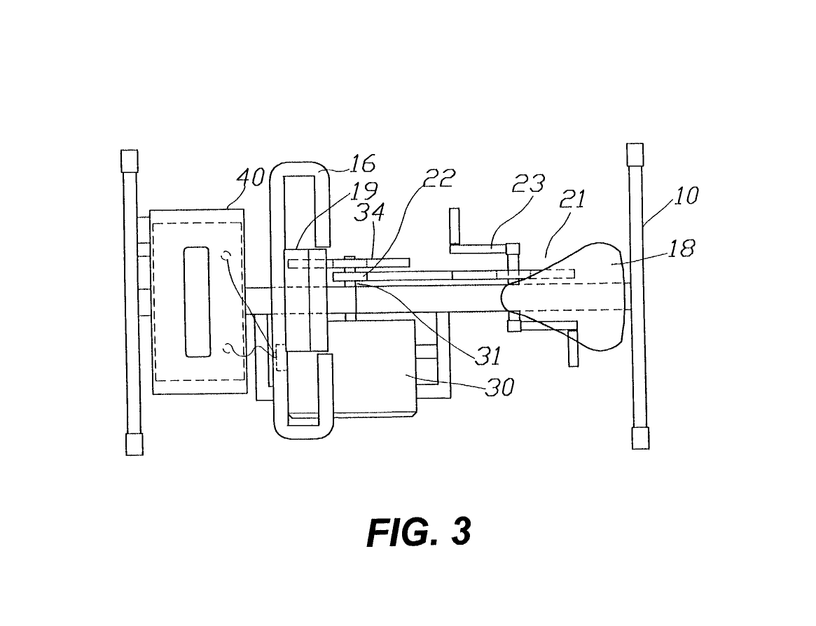

Referring to FIG. 1-3, the present invention will be described taking an exercise bike as an example for illustrating a preferred embodiment and not for giving any limitation to the scope thereof.

In the embodiment shown, a base 10 is provided, and a front pipe post 11 as well as a rear pipe post 12 are extended upwardly therefrom, and a horizontal pipe strut 13 and an inclined pipe strut 14 are added to together form a frame of the bike. There is another front pipe member 15 to form a handle 16 and its branch pipe 161. The rear pipe post 12 and the horizontal pipe strut 13 intercross and connect together with another pipe member 17 for mounting a seat cushion 18 and its branch pipe 181. And a display device 19 can be provided at a suitable position on the handle 16 and its branch pipe 161.

The abovementioned indoor exercise bike has a transmitting system including at least a chain connecting with a rear gear 21 with a larger diameter and a front gear 22 with a smaller diameter. And a pedal device 23 for treading is chain geared with the rear gear 21.

The main feature of the present invention is to transmit the dynamic force of the transmitting system of the sport appliance to an out-extending rotating axle 31 of an electric power generator 30 by means of a transmitting mechanism. The electric power generator 30 is connected to a chargeable battery device 40 through conductors 32, 33.

In the preferred embodiment shown in the drawings, the front gear 22 with a smaller diameter is coaxially geared with another rear gear 34 with a larger diameter which is further connected via a chain 35 to a gear 36 with a smaller diameter of the out-extending rotating axle 31 of the electric power generator 30. The unequal-speed structure makes the rotating axle 31 of the electric power generator 30 speed up rotating for enhancing electric power generation.

The abovementioned chargeable battery device 40 can be provided in a matchable container 50, more than one sockets or other display devices for showing situation of charging or consumption of electricity (not shown) can be provided on the container 50 through a connecting circuit structure between the container 50 and the chargeable battery device 40, so that an electric appliance (such as a lamp or electric fan) can be directly connected by insertion for use and to show the situation of use of electric power. The container 50 and the chargeable battery device 40 therein can also be provided to be portable as a whole. In the embodiment shown, the container 50 is provided with a handle 51 for carrying, thereby, the whole device can be moved after charging into another charging equipment with same structure, or is carried to a place in wanting of electricity.

In the indoor exercise bike disclosed above as an example of the present invention, when a user continuously treads the pedal device 23, the rotating axle 31 of the electric power generator 30 will be rotated continuously by the transmitting system to generate electric power to sustainedly charge the chargeable battery device 40. Under continuous exercising of the user for a long period of time, the electric energy converted from dynamic energy can continuously be stored as spare electric power. This not only can save energy, but also can prepare spare electric power for emergencies (such as power breakage in natural calamity).

The preferred embodiment has been described hereinabove only for illustrating the present invention, it is apparent that various changes and modifications might be made without departing from the scope of the invention. For example, the present invention can be used on other sport appliances than the exercise bike and still fall into the scope of the accompanying claims.

1. A dynamic energy storage device for sport appliances, being characterized by transmitting a dynamic force of the transmitting system of a sport appliance such as an exercise bike to an out-extending rotating axle of an electric power generator by means of a transmitting mechanism, wherein said electric power generator is connected to a chargeable battery device through conductors; said chargeable battery device is provided in a matchable container, more than one electric sockets or other display devices are provided on said container through a connecting circuit structure therein.

2. A dynamic energy storage device for sport appliances as claimed in claim 1, wherein,
said container and said chargeable battery device therein are provided to be portable as a whole.

3. A dynamic energy storage device for sport appliances as claimed in claim 1, wherein,
said transmitting mechanism speeds up rotating of a rotating axle of an electric power generator with an unequal-speed transmitting structure.
